(19) United States
(12) Patent Application Publication
(10) Pub. No.: US 2018/0345920 A1
(43) Pub. Date: Dec. 6, 2018

(54) VEHICLE HAVING ELECTRIC PARKING BRAKE

(71) Applicant: GM GLOBAL TECHNOLOGY OPERATIONS LLC, Detroit, MI (US)

(72) Inventors: Eric E. Krueger, Chelsea, MI (US); Steven J. Weber, Mount Clemens, MI (US); Brian W. Quinn, Macomb Township, MI (US); James A. Webster, Shelby Township, MI (US)

(21) Appl. No.: 15/757,785

(22) PCT Filed: Sep. 8, 2016
(86) PCT No.: PCT/US2016/050620

§ 371 Date: Mar. 6, 2018

Related U.S. Application Data
(60) Provisional application No. 62/217,829, filed on Sep. 12, 2015.

(51) Int. Cl. B60T 7/04; B60T 1/10; B60T 13/58; B60T 13/66; B60T 13/74

(52) U.S. Cl. CPC B60T 7/042; B60T 1/10; B60T 13/586; B60T 2270/60; B60T 13/662; B60T 13/741; B60T 2201/03; B60T 13/588

(57) ABSTRACT

A vehicle having an electronic parking brake system is provided. The vehicle includes a braking system having a first rotor and a first caliper. An electric motor is coupled to operate the first caliper. At least one sensor coupled to the vehicle to determine a braking characteristic. A controller electrically is coupled to the electric motor and the at least one sensor, the controller transmitting a first signal to the electric motor in response to receiving a second signal from the at least one sensor and determining that the braking system is performing below a predetermined level, the electric motor actuating the first caliper to apply a clamping force on the first rotor in response to the first signal.

### CROSS-REFERENCE TO RELATED APPLICATIONS

The present application is a Nonprovisional Application of U.S. Provisional Application Ser. No. 62/217,829 filed on Sep. 12, 2015, the contents of which are incorporated by reference in their entirety.

### FIELD OF INVENTION

The subject invention relates to a vehicle having an electronic parking brake, and more particularly, to a vehicle that is configured to use the electronic parking brake to slow or stop the vehicle.

### BACKGROUND

Vehicles, such as automobiles and trucks for example, include a service braking system for slowing or stopping the vehicle in response to a deceleration action (e.g. stepping on a pedal) from the operator. Vehicles also typically have a second braking system that is used to hold the vehicle at a stopped position, such as when the vehicle is parked. This second braking system is sometimes colloquially referred to as a “parking brake.” Traditionally the parking brake was a mechanical system that included a lever or a pedal accessible by the vehicle operator. The lever was connected by a cable to the vehicles rear brakes. In response to the actuation of the lever, the rear brakes engage to maintain the vehicle in position.

More modern vehicles have been developed that utilize a parking brake system where the actuator used by the vehicle operator is not mechanically connected to the vehicle's front or rear brakes. In these vehicles, the actuator located in the passenger compartment transmits a signal to a controller. In response, the controller actuates a device, such as an electric motor for example, that activates the vehicle brakes to hold the vehicle in position. These electronic parking brakes are not otherwise controlled by the vehicle's control system except in response to a manual action by the operator

Accordingly, it is desirable to provide a vehicle having an electronic parking brake system with increased functionality.

### SUMMARY OF THE INVENTION

In one exemplary embodiment of the invention, a vehicle is provided. The vehicle comprising a braking system having a first rotor and a first caliper. An electric motor is coupled to operate the first caliper. At least one sensor coupled to the vehicle to determine a braking characteristic. A controller electrically is coupled to the electric motor and the at least one sensor, the controller transmitting a first signal to the electric motor in response to receiving a second signal from the at least one sensor and determining that the braking system is performing below a predetermined level, the electric motor actuating the first caliper to apply a clamping force on the first rotor in response to the first signal.

In another embodiment of the invention, a method of operating a vehicle is provided. The method includes determining a braking characteristic with at least one sensor. It is then determined that a braking system is performing below a predetermined level based at least in part on the determined braking characteristic, the braking system having a hydraulic braking portion and an electrical braking portion. The electrical braking portion is actuated based on the braking system performing below the predetermined level.

The above features and advantages and other features and advantages of the invention are readily apparent from the following detailed description of the invention when taken in connection with the accompanying drawings.

### BRIEF DESCRIPTION OF THE DRAWINGS

Other features, advantages and details appear, by way of example only, in the following detailed description of embodiments, the detailed description referring to the drawings in which:

FIG. 1 is a top schematic view of a vehicle having an electronic braking system in accordance with an embodiment of the invention;

FIG. 2 is a top schematic view of a hybrid vehicle having an electronic braking system in accordance with another embodiment of the invention;

FIG. 3 is a block diagram of an electronic brake control system in accordance with an embodiment of the invention; and

FIG. 4 is a block diagram of an electronic brake control system in accordance with another embodiment of the invention.

### DESCRIPTION OF THE EMBODIMENTS

The following description is merely exemplary in nature and is not intended to limit the present disclosure, its application or uses. It should be understood that throughout the drawings, corresponding reference numerals indicate like or corresponding parts and features.

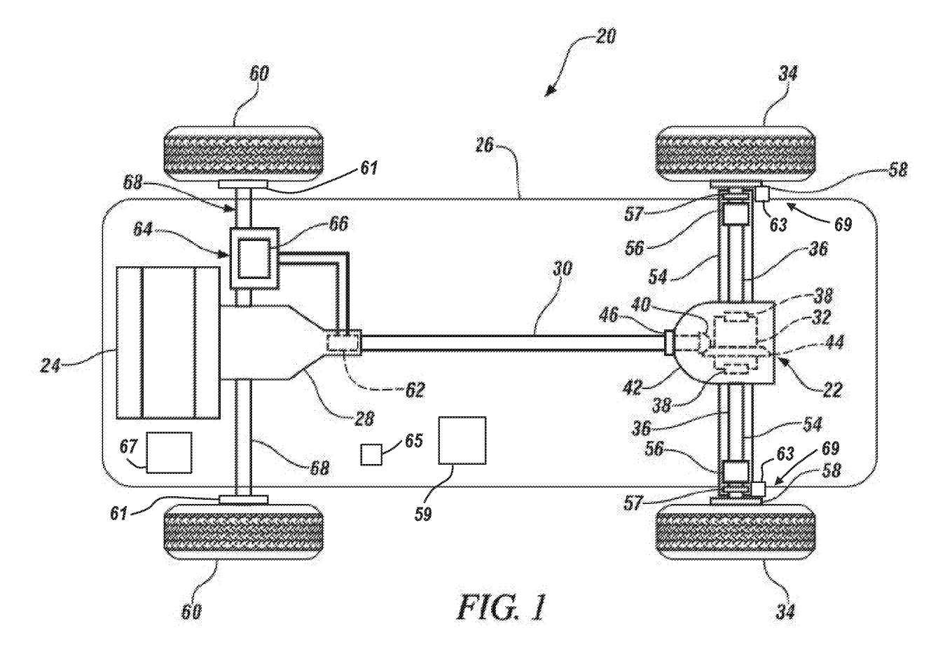

In accordance with an embodiment of the invention, FIG. 1 illustrates a vehicle 20 having a differential assembly 22. The differential assembly 22 may sometimes be referred to as a rear drive module. It should be appreciated that the vehicle 20 may be an automobile, truck, van or sport utility vehicle for example. As used herein, the term vehicle is not limited to just an automobile, truck, van or sport utility vehicle, but may also include any self-propelled or towed conveyance suitable for transporting a burden. The vehicle 20 may include a vehicle propulsion system 24, such as a gasoline or diesel fueled internal combustion engine for example. The propulsion system 24 may further be a hybrid type engine that combines an internal combustion power source with an electrical motor power source for example. The propulsion system 24 and differential assembly 22 are coupled to a frame or other chassis structure 26. The propulsion system 24 is coupled to the rear differential assembly 22 by a transmission 28 and a driveshaft 30. The transmission 28 may be configured to reduce the rotational velocity and increase the torque of the engine output. This modified output is then transmitted to the differential assembly 22 via the driveshaft 30. The rear differential assembly 22 transmits the output torque from the driveshaft 30 through a differential gear set 32 to a pair of driven-wheels 34 via axles 36.

The differential gear set 32 is arranged within a differential housing 42. The differential gear set 32 receives the output from the driveshaft 30 via a pinion 40 that transmits the torque to a ring gear 44. The pinion 40 includes a shaft that is coupled to the driveshaft 30 by a flange 46. The differential gear set 32 is supported for rotation within the housing 42 by a pair of differential bearings. The differential gear set 32 includes side gears 38 arranged within the housing 42 that are coupled to and support one end of the axles 36. The coupling of rotational components, such as the flange 46 to the pinion 40 or the side gears 38 to the axles 36 for example, may be accomplished using a spline connection.

In one embodiment, each axle 36 extends through an axle tube 54. The axle tube 54 includes a hollow interior that extends the length thereof. At one end of the axle tube 54 a bearing 56 is mounted to support the end of the axle 36 adjacent the driven-wheel 34. A shaft seal 57 is located between the bearing 56 and the driven-wheel 34. A brake assembly 58 is coupled to the end of the axle 36 adjacent the bearing 56. The brake assembly 58 is configured to selectively slow the rotation of the wheel 34 in response to an action by the operator, such as applying the brake pedal or activating the parking brake. The brake assembly 58 may be any known braking system used with vehicles, such as a caliper/rotor assembly. In the exemplary embodiment, the brake assembly 58 is connected to a hydraulic circuit that is driven by a hydraulic system 59. The hydraulic system 59 may include a booster device that increases the amount of hydraulic force that is applied to the brakes 58 in response to a deceleration action by the operator. The hydraulic system 59 may be driven by the propulsion system 24 or electrically driven by a separate electrical motor (not shown).

The brake assembly 58 is also configured to function as a parking brake. In the exemplary embodiment, the brake assembly 58 includes an electronic parking brake system 69 having an electrical motor 63 that is coupled to actuate a brake caliper or drum/shoe. When a parking brake is activated by the operator (such as with an button or actuator 65) the motors 63 actuate the calipers to apply a brake clamping force onto the respective brake rotors. The electronic parking brake system 69 and the actuator 65 are coupled to a controller 67.

The vehicle 20 further includes a second set of wheels 60 arranged adjacent the propulsion system 24. In one embodiment, the second set of wheels 60 is also configured to receive output from the propulsion system 24. This is sometimes referred to as a four-wheel or an all-wheel drive configuration. In this embodiment, the vehicle 20 may include a transfer case 62 that divides the output from the transmission 28 between the front and rear driven wheels 34, 60. The transfer case 62 transmits a portion of the output to a front differential assembly 64, which may include additional components such as a differential gear set 66 and axles 68 that transmit the output to the wheels 60. Similar to the rear wheels 34, the front wheels 60 include brake assemblies 61. The brake assemblies 61 are configured to selectively slow the rotation of the front wheels 60 in response to a deceleration action by the operator. In the exemplary embodiment, the brake assemblies 61 are also coupled to and actuated by the hydraulic system 59. In one embodiment, the system 59 is configured to selectively isolate hydraulic pressure applied to the front brake assemblies 61 from the rear brakes 58 as is discussed in more detail herein.

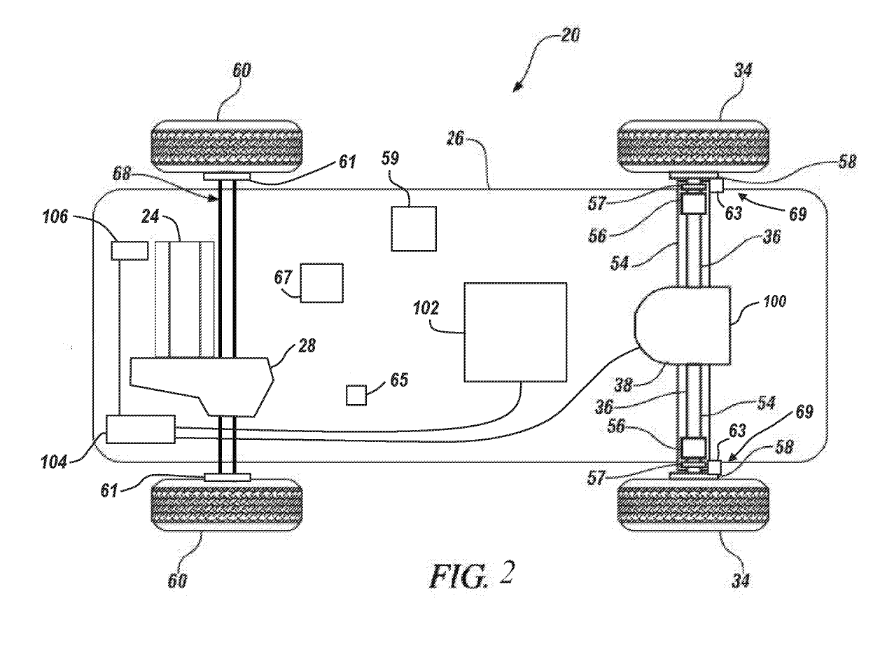

Referring now to FIG. 2, another type of vehicle 20 is shown. In this embodiment, the vehicle 20 includes a rear drive system 100 having a propulsion system 24 that uses electrical power from a battery system 102 to provide electrical power to the rear wheels 34. The rear drive system 100 includes one or more electrical motors (not shown) that are coupled to the rear axles 36 to transfer torque to the rear wheels 34. The battery system 102 is connected to the rear drive system 100 via a power controller 104. A charging system 106 (e.g. a belt driven alternator or generator) may be connected between the propulsion system 24 and the power controller 104 to provide electrical power for replenishing the battery system 102. In some embodiments, the electrical power may be provided by, or supplemented by, a regenerative braking system. In an embodiment, the regenerative braking system may be incorporated into the rear drive system 100. It should be appreciated that the electronic braking system 69 described herein may be used with any type of vehicle, such as the vehicles 20 shown in FIG. 1 and FIG. 2. In other embodiments, the vehicle 20 may also be an all-electric vehicle (e.g. electric motors provide torque to both the front and rear wheels 34, 60).

Traditionally, parking brake systems are configured to be applied quickly and with a fixed, predetermined amount of clamping force. As a result, if the vehicle is moving when the parking brake is applied, the vehicle will come to an abrupt stop. In accordance with embodiments described herein, a parking brake may also be used to aid the operator when the regular hydraulic braking system is operating at a level below a predetermined performance level, such as due to a loss of electrical power or from a vacuum leak for example.

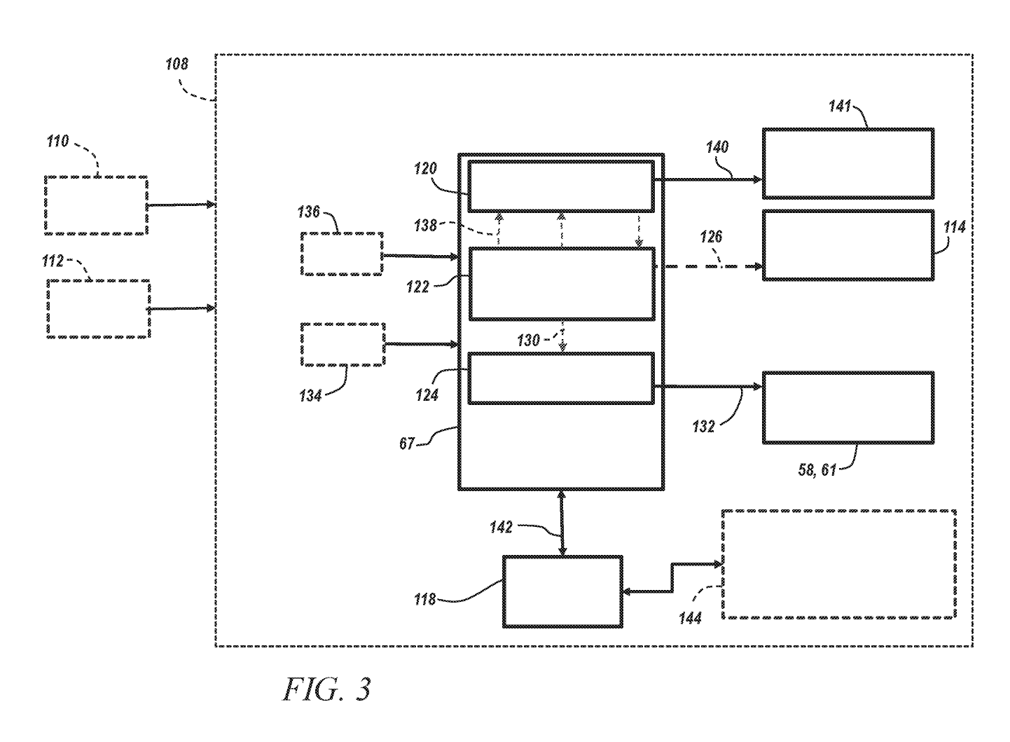

In accordance with one embodiment, when the regular hydraulic braking system 59 is operating below a predetermined performance level, the controller 67 may utilize the electronic braking system 69 to slow the vehicle. In an embodiment, the electronic braking system 69 may be a parking brake system. It should be appreciated that while embodiments herein refer to an electric or a hydraulic braking system, this is for exemplary purposes and the claimed invention should not be so limited. In other embodiments, other types of braking systems may be used. It should be appreciated that when the regular hydraulic braking system 59 is not operating as desired, the operator may have to apply increased pedal pressure and may experience longer pedal travel. By operating the electric motors 63 of the electronic braking system 69 with a linear response, proportional to the drivers braking command, the speed of the vehicle 20 may be reduced while decreasing the amount effort by the operator. In one embodiment, the electric motors 63 are driven with a linear response when the operator performs a deceleration action such as pressing on the brake pedal. The operator's deceleration actions may be determined from brake apply sensors 134 (FIG. 3), such as a sensor that determines brake pedal travel or a sensor for measuring brake pedal force.

In one embodiment, the electronic parking brake system 69 is used in a linear proportional manner based on the brake pedal travel. In one embodiment, the electronic parking brake system 69 is applied early in the pedal stroke (e.g. at or close to the initiation of brake pedal travel) rather than waiting for further travel in the brake pedal stroke. In an embodiment the electronic parking brake system 69 initiates within the first 10 mm of brake travel, or in the first 0%-5% of the total brake pedal travel distance. In some prior art systems, some vehicles included a booster (e.g. pressure boost module 124, FIG. 3) in the braking system that initiate later in the brake pedal travel. As a result, the brake pedal will travel a significant distance before the operator experienced the desired braking. This is sometimes referred to as long pedal stroke. Embodiments disclosed herein may provide advantages in resolving the long pedal stroke that may result from use of the booster alone. As used herein, the phrase “long brake pedal” refers to the operator having to depress the brake pedal a significant distance along the total brake pedal travel before the desired rate of deceleration of the vehicle is achieved. In an embodiment, the booster initiates after 20 mm of brake travel, or after 8-10% of the total brake pedal travel distance.

In an embodiment, the electronic parking brake system 69 may utilize a dynamic deceleration electronic parking brake slip control function when the electronic parking brake is on the rear axle.

In one embodiment, the electronic braking system 69 is only arranged to cooperate with the rear wheels 34 as illustrated in FIG. 1 and FIG. 2. In this embodiment, the rear brakes 58 may be hydraulically isolated from the front brakes, such as through a manifold or valve coupled to the hydraulic system 59 for example. By hydraulically isolating the rear brakes 58, the electronic braking system 69 may provide improved braking control without the operator's application of the brake pedal. Further advantages are gained since the isolation of the rear brakes 58 also reduces the effort for the operator by reducing the pedal travel of the brake pedal as the brake fluid volume within the hydraulic system 59 is reduced. It should be appreciated that while embodiments herein describe the electronic parking brake as being coupled to the rear wheels 34, this is for exemplary purposes and the claimed invention should not be so limited. In other embodiments, the electronic parking brake system 69 may be coupled to the front wheels 60 or to both the front and rear wheels 34, 60.

It should be appreciated that application of the electronic braking system 69 may be adjusted based on the operational characteristics of the vehicle 20. For example, when the vehicle 20 is traveling at a slower speed the controller 67 may operate the motor 63 to apply an increased amount of clamping force to the brake rotor at a faster rate than if the vehicle 20 is travelling at a higher speed. Further, the controller 67 may monitor the wheels 34 and determine if there is any rear wheel 34 lockup and adjust the amount of clamping force on the rotor to alleviate or prevent the lockup from occurring.

Referring now to FIG. 3 with continuing reference to FIG. 1, an embodiment is shown of control system 108 for the electronic parking brake system 69. The control system 108 receives inputs, such as user input 110 and environmental inputs 112 for example. The control system 108 includes the electronic brake controller 67, an engine/transmission control module 114 and a body control module 118. The controller 67 is configured to communicate with each of the modules 114, 118. It should be appreciated that the control system 108 may include other modules used in the operation of the vehicle 20; as is known in the art. It should be appreciated that the control system 108 may also include fewer modules. In some embodiments a brake assist module 122 may not transmit signals to the ECM 114.

The electronic brake controller 67 includes sub-modules, such as electronic parking brake module 120, brake assist module 122 and pressure boost module 124. The brake assist module 122 determines parameters associated with deceleration actions by the operator and determines if assistance should be provided to aid the operator and how much assistance is to be applied. The brake assist module 122 may send a signal 126 to the engine control module 114 to request that the engine reduce the power output. This action will aid in decelerating the vehicle 20. It should be appreciated that in other embodiments, the modules 67, 120, 122, 124 may be embodied in separate components and arranged in a distributed manner rather than an integrated control scheme as illustrated.

The brake assist module 122 may further transmit a signal 130 to the pressure boost module 124 to change the amount of pressure a brake booster is applying to the brake hydraulic system 59. The pressure boost module 124 in turn changes the hydraulic pressure 132 applied to the wheel brakes 58, 61. The brake assist module 122 further monitors the operation of the vehicle 20 such as via the brake apply sensors 134 (e.g. brake pedal travel and brake pedal force) and the wheel speed sensors 136.

In the event that the brake assist module 122 determines (e.g. via sensors 134, 136) that the hydraulic braking system 59 is not operating at a desired performance level, a signal 138 may be transmitted to the electronic parking brake module 120. The signal 138 may include a desired rotor clamp load for example. It should be appreciated that brake assist module 122 may also transmit a signal 130 to the boost module 124 to hydraulically isolate the rear brakes 58 from the front brakes 61. The electronic parking brake module 120 transmits a signal 140 to a module 141 that actuates the motors 63 causing the brake calipers to clamp the rotors with the desired amount of clamping force. In one embodiment, the clamping force is proportional to the deceleration request from the operator.

In one embodiment, the electronic brake control module 67 may also transmit a signal 142 to the body control module 118 to notify the operator, such as through a dashboard display 144 that the electronic braking system 69 was used to assist with braking and that brake servicing may be desired.

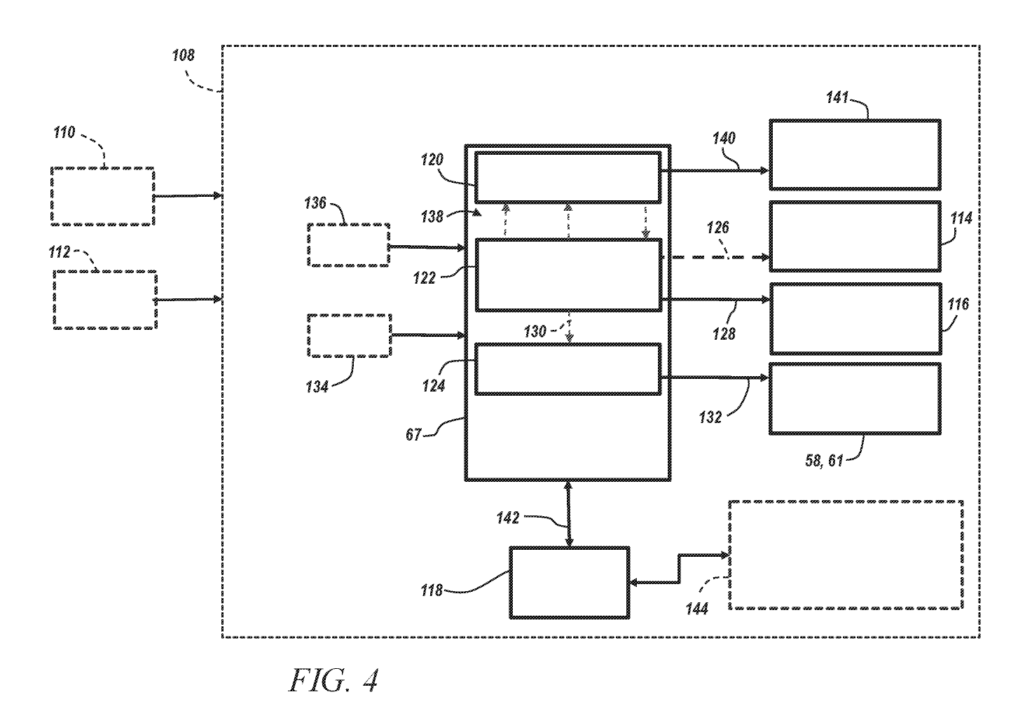

Referring now to FIG. 4 with continuing reference to FIG. 2, another embodiment is shown of the control system 108. This embodiment is substantially the same as that shown and described with respect to FIG. 3. In this embodiment, the control system 108 also includes a hybrid control module 116 for use with a vehicle such as that shown in FIG. 2. The module 116 provides control functionality to the hybrid vehicle components, such as a regenerative braking system that generates electrical power for recharging the battery 102. It should be appreciated that when the regenerative brake system is engaged, a resistance or load is placed on the wheels 34 that results in the vehicle 20 slowing down. In one embodiment, the brake assist module 122 may transmit a signal 128 to the hybrid control module 116. The signal 128 causes the hybrid control module 116 to engage the regenerative brake system to assist in slowing down the vehicle 20 when the hydraulic braking system 59 is not operating at a desired performance level.

Embodiments of the present invention provide advantages in lowering the amount of effort required by the drive to stop a vehicle. Further advantages are provided in reducing the amount of pedal travel required to stop the vehicle.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed, but that the invention will include all embodiments falling within the scope of the application.

1. A vehicle comprising:
a braking system having a first rotor and a first caliper;
an electric motor coupled to operate the first caliper;
at least one sensor coupled to the vehicle to determine a braking characteristic; and
a controller electrically coupled to the electric motor and the at least one sensor, the controller being configured to transmit a first signal to the electric motor in response to receiving a second signal from the at least one sensor and determining that the braking system is performing below a predetermined level, the electric motor being configured to actuate the first caliper to apply a clamping force on the first rotor in response to the first signal.

2. The vehicle of claim 1 wherein the braking system further comprises a second rotor and a second caliper, and a hydraulic circuit coupled to the first caliper and the second caliper.

3. The vehicle of claim 2 wherein the controller is further responsive to hydraulically isolating a first portion of the hydraulic circuit coupled to the first caliper from a second portion of the hydraulic circuit coupled to the second caliper.

4. The vehicle of claim 3 wherein the first caliper is coupled to a rear wheel and the second caliper is coupled to a front wheel.

5. The vehicle of claim 3 wherein the first caliper is coupled to a front wheel and the second caliper coupled to a rear wheel.

6. The vehicle of claim 1 wherein the controller is further responsive to determine a speed of the vehicle and a change the clamping force based at least in part on the speed of the vehicle and in proportion to a travel distance of a brake pedal.

7. The vehicle of claim 3 wherein the controller further comprises:
a brake assist module, the brake assist module being electrically coupled to the at least one sensor and the electric motor; and
a pressure boost module coupled for communication to the brake assist module, the pressure boost module being configured to hydraulically isolate the first portion and the second portion based on a third signal from the brake assist module.

8. The vehicle of claim 7 wherein the at least one sensor is a brake pedal travel sensor, a brake pedal force sensor, or a wheel speed sensor.

9. The vehicle of claim 7 wherein the controller further includes an engine control module electrically coupled to the brake assist module, the engine control module being responsive to reduce a power output of a vehicle propulsion system in response to a fourth signal from the brake assist module.

10. The vehicle of claim 9 wherein the vehicle propulsion system is one of an internal combustion power source, a combination electrical-motor and internal combustion power source, or an electrical motor power source.

11. The vehicle of claim 10 wherein the vehicle propulsion system is a hybrid electrical/internal-combustion power source and the reducing of power output includes activating a regenerative braking system.

12. A method of operating a vehicle comprising:
determining a braking characteristic with at least one sensor;
determining a braking system performance below a predetermined level based at least in part on the determined braking characteristic, the braking system having a hydraulic braking portion and an electrical braking portion; and
actuating the electrical braking portion based on the braking system performing below the predetermined level.

13. The method of claim 12 further comprising isolating a first portion of the hydraulic braking portion from a second portion of the hydraulic braking portion prior to actuating the electrical braking portion.

14. The method of claim 13 wherein the second portion is associated with the electrical braking portion.

15. The method of claim 13 further comprising determining a speed of the vehicle and changing a brake clamping force based on the determined speed of the vehicle.

16. The method of claim 13 further comprising reducing a power output of a vehicle propulsion system based at least in part on the braking system performing below the predetermined level.

17. The method of claim 16 wherein the vehicle propulsion system is one of an internal combustion power source, a combination electric motor and internal combustion power source or an electrical motor power source.

18. The method of claim 13 further comprising increasing a hydraulic pressure in the hydraulic braking portion based at least in part on the braking system performance below the predetermined level.

19. The method of claim 13 further comprising activating a regenerative braking system based at least in part on the braking system performance below the predetermined level.

20. The method of claim 13 wherein the at least one sensor includes a brake pedal travel sensor, a brake pedal force sensor, or a wheel speed sensor.
